(19) United States
(12) Patent Application Publication
(10) Pub. No.: US 2015/0031433 A1
(43) Pub. Date: Jan. 29, 2015

(54) Number-Matching Game Board Apparatus and Method of Use Thereof

(71) Applicant: Sammy D. Porter, Bullhead City, AZ (US)

(72) Inventor: Sammy D. Porter, Bullhead City, AZ (US)

(21) Appl. No.: 14/341,757

(22) Filed: Jul. 25, 2014

Related U.S. Application Data
(60) Provisional application No. 61/858,142, filed on Jul. 25, 2013.

(51) Int. Cl. A63F 3/04; A63F 13/45; A63F 13/822; A63F 13/25

(52) U.S. Cl. CPC A63F 3/0415; A63F 13/25; A63F 13/45; A63F 13/822; A63F 2003/0418; A63F 2003/00996
USPC 463/13; 273/273

(57) ABSTRACT

A game board apparatus for a numbering matching game is played between two players. The apparatus includes a gridded board, a first set of sequentially numbered tiles, a second set of sequentially numbered tiles, a first numbered die, and a second numbered die. The dice are rolled by one player. The separate values of the dice or the combined values of the dice are marked on the gridded board by the player with their set of tiles. The aforementioned process is repeated by another player. Whichever player marks all of their corresponding blocks on the gridded board wins the game.

The current application claims a priority to the U.S. Provisional Patent application Ser. No. 61/858,142 filed on Jul. 25, 2013.

### FIELD OF THE INVENTION

The present invention relates generally to educational games and teaching aids. More specifically, the present invention is a number game in which two players attempt to place all game pieces on a board in a shorter amount of time. The players utilize basic arithmetic throughout the course of the game.

### BACKGROUND OF THE INVENTION

Games are effective teaching aids that supplement traditional educational material. Educational games often attempt to integrate learning material into a fun and competitive experience that motivates students to apply the learned material. Several types of games introduce educational themes into traditional games such as Tic Tac Toe and Hangman. Other games simulate sports such as baseball and football wherein students must successfully complete educational activities or tasks to score points. Although recent times have seen an increase in electronic and online educational games, oftentimes it is more convenient to utilize physical game pieces. This is particularly the case when there are a large number of students participating in a game. The present invention seeks to provide a novel educational game and teaching aid that improves upon and enhances current existing educational games. The objective of the present invention is to provide a number game in which two players must place all of their respective game pieces on a board before the opponent is able to.

### BRIEF DESCRIPTION OF THE DRAWINGS

FIG. 1 is a perspective view of the number-matching game board apparatus.

FIG. 2 is a perspective view of the gridded board and each player's respective tiles in a winning configuration.

FIG. 3 is a flow chart describing the method of playing with the number-matching game board apparatus.

FIG. 4 is a flow chart describing the method of virtually playing with the number-matching game board apparatus through a software application.

### DETAILED DESCRIPTION OF THE INVENTION

All illustrations of the drawings are for the purpose of describing selected versions of the present invention and are not intended to limit the scope of the present invention.

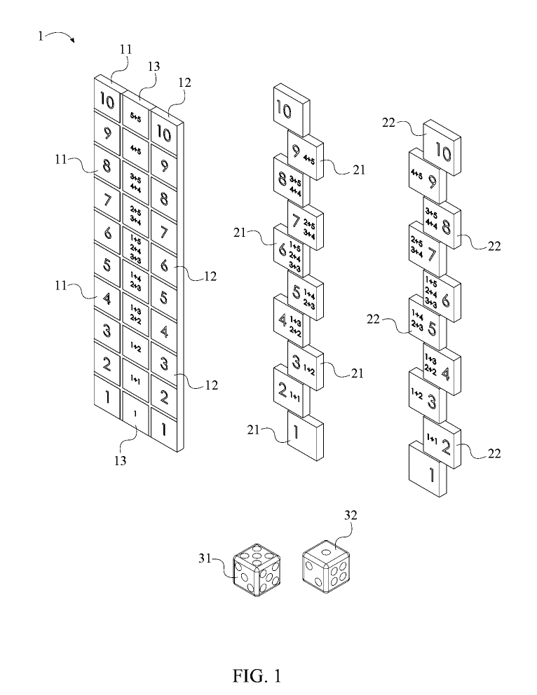

As can be seen in FIG. 1, the present invention is a number-matching game board apparatus and a method of use thereof. The number-matching game board apparatus comprises a gridded board 1, a first set of sequentially numbered tiles 21, a second set of sequentially numbered tiles 22, a first numbered die 31, and a second numbered die 32. The gridded board 1 is used to guide the game play for the players. The gridded board 1 comprises a first column of sequentially numbered blocks 11, a second column of sequentially numbered blocks 12, and a column of dice-combination reference blocks 13. The first column of sequentially numbered blocks 11 is used to record a value that is rolled by the first numbered die 31 and the second numbered die 32 by one player. Similarly, the second column of sequentially numbered blocks 12 is used to record a value that is rolled by the first numbered die 31 and the second numbered die 32 by another player. The first column of sequentially numbered blocks 11 and the second column of sequentially numbered blocks 12 are positioned opposite to each other across the gridded board 1 so that each player can use a designated side of the gridded board 1. The column of dice-combination reference blocks 13 is used to describe different combinations of dice rolls that can equal each value in the first column of sequentially numbered blocks 11 or in the second column of sequentially numbered blocks 12. The column of dice-combination reference blocks 13 is positioned in between the first column of sequentially numbered blocks 11 and the second column of sequentially numbered blocks 12.

The following specifics are for the most practical embodiment of the present invention. The gridded board 1 is dimensioned at 17.5″ by 5″ by ⅝″. The first set of sequentially numbered tiles 21 and the second set of sequentially numbered tiles 22 are each dimensioned at 1.75″ by 1.75″ by ¼″. The first column of sequentially numbered blocks 11, the second column of sequentially numbered blocks 12, and the column of dice-combination reference blocks 13 is dimensioned at 1″ by 1.75″. The first column of sequentially numbered blocks 11 is colored yellow or red. The second column of sequentially numbered blocks 12 is colored white. The column of dice-combination reference blocks 13 is oppositely colored red or yellow.

The first set of sequentially numbered tiles 21 is used to mark a value on the first column of sequentially numbered blocks 11 that is rolled by the first numbered die 31 and the second numbered die 32 by one player. More specifically, a selected tile from the first set of sequentially numbered tiles 21 is positioned adjacent to a corresponding block from the first column of sequentially numbered blocks 11. The selected tile and the corresponding block are meant to share the same numeric value. In the preferred embodiment of the present invention, each of the first set of sequentially numbered tiles 21 is uniquely printed with a number between a range of one to ten, and each of the first column of sequentially numbered blocks 11 is uniquely printed with a number between a range of one to ten.

Likewise, the second set of sequentially numbered tiles 22 is used to mark a value on the second column of sequentially numbered blocks 12 that is rolled by the first numbered die 31 and the second numbered die 32 by one player. More specifically, a selected tile from the second set of sequentially numbered tiles 22 is positioned adjacent to a corresponding block from the second column of sequentially numbered blocks 12. The selected tile and the corresponding block are meant to share the same numeric value. In the preferred embodiment of the present invention, each of the second set of sequentially numbered tiles 22 is uniquely printed with a number between a range of one to ten, and each of second column of sequentially numbered blocks 12 is uniquely printed with a number between a range of one to ten.

Also in the preferred embodiment of the present invention, the first numbered die 31 and the second numbered die 32 are designed to have a lower probability of rolling a high value and a higher probability of rolling a low value. The first numbered die 31 and the second numbered die 32 each comprise six sides. Each of five of the six sides is uniquely printed with a number between a range of one to five, and the last of the six sides is printed with a number five. In other embodiments of the present invention, the first set of sequentially numbered tiles 21, the second set of sequentially numbered tiles 22, the first column of sequentially numbered blocks 11, the second column of sequentially numbered blocks 12, and the column of dice-combination reference blocks 13 can be valued so that the present invention can be played with other arithmetic operations such as subtraction, multiplication, and division instead of just addition.

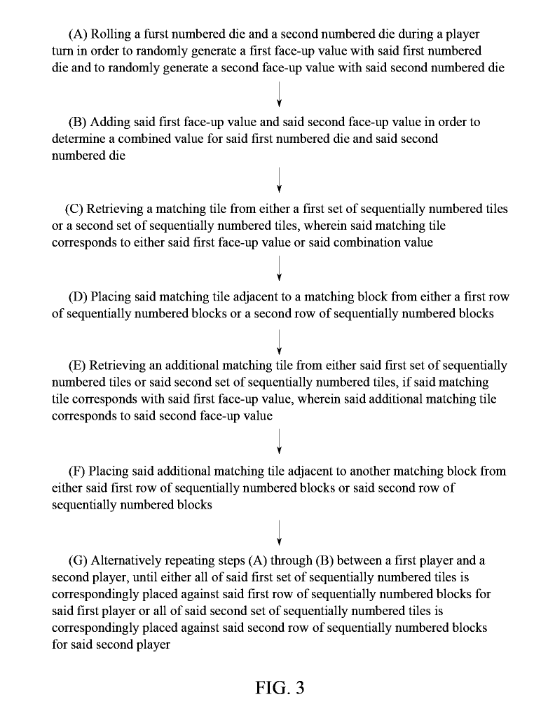

As can be seen in FIG. 3, the method of playing with the number-matching game board apparatus is done with a first player and a second player. Consequently, the first player is associated with the first column of sequentially numbered blocks 11 and the first set of sequentially numbered tiles 21, and the second player is associated with the second column of sequentially numbered blocks 12 and the second set of sequentially numbered tiles 22. Either the first player or the second player, during their turn, can roll the first numbered die 31 and the second numbered die 32 in order to randomly generate a first face-up value with the first numbered die 31 and in order to randomly generate a second face-up value with the second numbered die 32. The first face-up value and the second face-up value is the value of the upward face on a numbered die. The method continues by adding the first face-up value and the second face-up value in order to determine a combined value for the first numbered die 31 and the second numbered die 32. The column of dice-combination reference blocks 13 can be referenced by the first player or the second player. For example, if the first numbered die 31 rolls a “three” and the second numbered die 32 rolls a “four”, then the first face-up value is “three”, the second face-up value is “four”, and the combined value is “seven”.

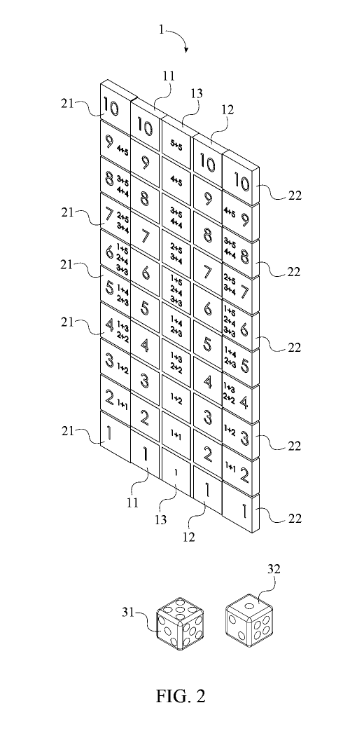

The method proceeds by retrieving a matching tile from either the first set of sequentially numbered tiles 21 or the second set of sequentially numbered tiles 22. The matching tile will correspond to either the first face-up value or the combined value. The method continues by placing the matching tile adjacent to a matching block from either the first column of the sequentially numbered blocks or the second column of the sequentially numbered blocks, which allows a player to record which values have been rolled on their turn with the gridded board 1. If a player chooses the matching tile that corresponds with the first face-up value, then an additional matching tile is retrieved from the either the first set of sequentially numbered tiles 21 or the second set of sequentially numbered tiles 22. The additional matching tile will correspond to the second face-up value. The method continues by placing the additional matching tile adjacent to another matching block from the first column of sequentially numbered blocks 11 or the second column of sequentially numbered blocks 12. Finally, the aforementioned steps are alternatively repeated by the first player and the second player, until either all of the first set of sequentially numbered tiles 21 is correspondingly placed against the first column of sequentially numbered blocks 11, which allows the first player to win the game, or all of the second set of sequentially numbered tiles 22 is correspondingly placed against the second column of sequentially numbered blocks 12, which allows the second player to win the game. This placement can be seen in FIG. 2.

Moreover on the preferred embodiment of the present invention, the first numbered die 31 has a one-sixth probability of rolling one as the first face-up value, a one-sixth probability of rolling two as the first face-up value, a one-sixth probability of rolling three as the first face-up value, a one-sixth probability of rolling four as the first face-up value, and a two-sixth probability of rolling five as the first face-up value. Similarly, the second numbered die 32 has a one-sixth probability of rolling one as the second face-up value, a one-sixth probability of rolling two as the second face-up value, a one-sixth probability of rolling three as the second face-up value, a one-sixth probability of rolling four as the second face-up value, and a two-sixth probability of rolling five as the second face-up value.

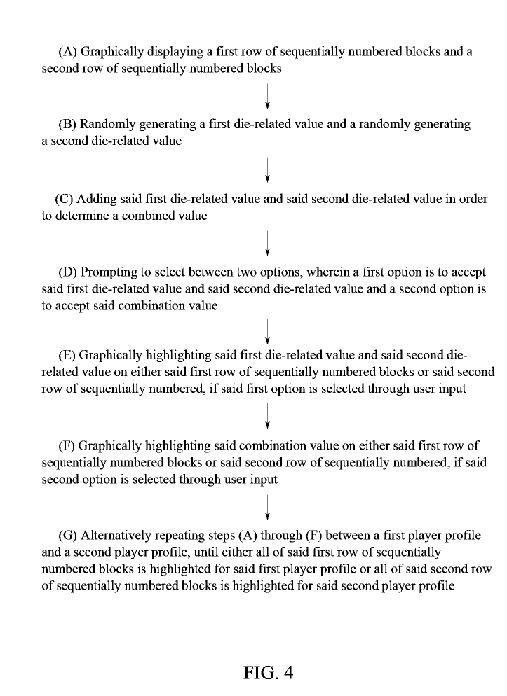

As can be seen in FIG. 4, the method of playing with the number-matching game board apparatus can be virtualized as computer software application by executing computer-executable instructions stored on a non-transitory computer-readable medium. The first player will interface with software application through a first player profile, and the second player will interface with the software application through a second player profile. This method begins by graphically displaying the first column of sequentially numbered blocks 11 and the second column of sequentially numbered blocks 12 to the first player profile and the second player profile. The method continues by randomly generating a first die-related value and a second die-related value, which allows the software application to mimic the action of rolling dice for two random values. The software application proceeds to add the first die-related value and the second die-related value in order to determine a combined value. The column of dice-combination reference blocks 13 can also be graphically displayed between the first column of sequentially numbered blocks 11 and the second column of sequentially numbered blocks 12. Similar to the previous example, if the software application randomly generates “three” as the first die-related value and “four” as the second die-related value, then the combined value is “seven”.

The method continues by prompting to separately select between two options: a first option is to accept the first die-related value, and the second option is to accept the second die-related value. If the first option is selected by either the first player profile or the second player profile, then the software application is graphically highlighting the first die-related value and the second die-related value on either the first column of sequentially numbered blocks 11 or the second column of sequentially numbered blocks 12. If the second option is selected by either the first player profile or the second player profile, then the software application is graphically highlighting the combined value on either the first column of sequentially numbered blocks 11 or the second column of sequentially numbered blocks 12. Finally, the aforementioned steps will alternatively repeat between the first player profile and the second player profile, until either all of the first column of sequentially numbered blocks 11 is highlighted for the first player profile, which allows the first player to win the game, or all of the second column of sequentially numbered blocks 12 is highlighted for the second player profile, which allows the second player to win the game.

In preferred embodiment, more specified values allow the software application to be more game and dice related. One such specific is that the first die-related value has a one-sixth probability of being one, a one-sixth probability of being two, a one-sixth probability of being three, a one-sixth probability of being four, and a two-sixth probability of being five. Similarly, another such specific is that the second die-related value has a one-sixth probability of being one, a one-sixth probability of being two, a one-sixth probability of being three, a one-sixth probability of being four, and a two-sixth probability of being five. Another such specific is that the first column of sequentially numbered blocks 11 is a range between one and ten. Another such specific is that the second column of sequentially numbered blocks 12 is a range between one and ten.

Although the invention has been explained in relation to its preferred embodiment, it is to be understood that many other possible modifications and variations can be made without departing from the spirit and scope of the invention as hereinafter claimed.

What is claimed is:

1. A number-matching game board apparatus comprises:
a gridded board;
a first set of sequentially numbered tiles;
a second set of sequentially numbered tiles;
a first numbered die;
a second numbered die;
said gridded board comprises a first column of sequentially numbered blocks, a second column of sequentially numbered blocks, and a column of dice-combination reference blocks;
said first column of sequentially numbered blocks and said second column of sequentially numbered blocks being positioned opposite to each other across said gridded board; and
said column of dice-combination reference blocks being positioned in between the first column of sequentially numbered blocks and said second column of sequentially numbered blocks.

2. The number-matching game board apparatus as claimed in claim 1 comprises:
a selected tile from said first set of sequentially numbered tiles being positioned adjacent to a corresponding block from said first column of sequentially numbered blocks.

3. The number-matching game board apparatus as claimed in claim 1 comprises:
each of said first set of sequentially numbered tiles being uniquely printed with a number between a range of one to ten; and
each of said first column of sequentially numbered blocks being uniquely printed with a number between a range of one to ten.

4. The number-matching game board apparatus as claimed in claim 1 comprises:
a selected tile from said second set of sequentially numbered tiles being positioned adjacent to a corresponding block from said second column of sequentially numbered blocks.

5. The number-matching game board apparatus as claimed in claim 1 comprises:
each of said second set of sequentially numbered tiles being uniquely printed with a number between a range of one to ten; and
each of said second column of sequentially numbered blocks being uniquely printed with a number between a range of one to ten.

6. The number-matching game board apparatus as claimed in claim 1 comprises:
said first numbered die and said second numbered die each comprises six sides;
each of five of said six sides being uniquely printed with a number between a range of one to five; and
last of said six sides being printed with a number five.

7. A method of playing with the number-matching game board apparatus as claimed in claim 1, the method comprises the steps of:
(A) rolling said first numbered die and said second numbered die during a player turn in order to randomly generate a first face-up value with said first numbered die and to randomly generate a second face-up value with said second numbered die;
(B) adding said first face-up value and said second face-up value in order to determine a combined value for said first numbered die and said second numbered die;
(C) retrieving a matching tile from either said first set of sequentially numbered tiles or said second set of sequentially numbered tiles, wherein said matching tile corresponds to either said first face-up value or said combined value;
(D) placing said matching tile adjacent to a matching block from either said first column of sequentially numbered blocks or said second column of sequentially numbered blocks;
(E) retrieving an additional matching tile from either said first set of sequentially numbered tiles or said second set of sequentially numbered tiles,
if said matching tile corresponds with said first face-up value, wherein said additional matching tile corresponds to said second face-up value;
(F) placing said additional matching tile adjacent to another matching block from either said first column of sequentially numbered blocks or said second column of sequentially numbered blocks; and
(G) alternatively repeating steps (A) through (B) between a first player and a second player, until either all of said first set of sequentially numbered tiles is correspondingly placed against said first column of sequentially numbered blocks for said first player or all of said second set of sequentially numbered tiles is correspondingly placed against said second column of sequentially numbered blocks for said second player.

8. The method of playing with the number-matching game board apparatus as claimed in claim 7, wherein said column of dice-combination reference blocks is referenced in order to determine said combination value.

9. The method of playing with the number-matching game board apparatus as claimed in claim 7, wherein said first numbered die has a one-sixth probability of rolling one as said first face-up value, a one-sixth probability of rolling two as said first face-up value, a one-sixth probability of rolling three as said first face-up value, a one-sixth probability of rolling four as said first face-up value, and a two-sixth probability of rolling five as said first face-up value.

10. The method of playing with the number-matching game board apparatus as claimed in claim 7, wherein said second numbered die has a one-sixth probability of rolling one as said second face-up value, a one-sixth probability of rolling two as said second face-up value, a one-sixth probability of rolling three as said second face-up value, a one-sixth probability of rolling four as said second face-up value, and a two-sixth probability of rolling five as said second face-up value.

11. A method of playing with the number-matching game by executing computer-executable instructions stored on a non-transitory computer-readable medium, the method comprises the steps of:
(A) graphically displaying a first column of sequentially numbered blocks and a second column of sequentially numbered blocks;
(B) randomly generating a first die-related value and randomly generating a second die-related value;
(C) adding said first die-related value and said second die-related value in order to determine a combined value;
(D) prompting to select between two options, wherein a first option is to separately accept said first die-related value and said second die-related value, and a second option is to accept said combined value;
(E) graphically highlighting said first die-related value and said second die-related value on either said first column of sequentially numbered blocks or said second column of sequentially numbered blocks, if said first option is selected through user input;
(F) graphically highlighting said combined value on either said first column of sequentially numbered blocks or said second column of sequentially numbered blocks, if said second option is selected through user input; and
(G) alternatively repeating steps (A) through (F) between a first player profile and a second player profile, until either all of said first column of sequentially numbered blocks is highlighted for the first player profile or all of said second column of sequentially numbered blocks is highlighted for the second player profile.

12. The method of playing with the number-matching game board apparatus as claimed in claim 10, the method comprises the step of:
graphically displaying said column of dice-combination reference blocks in between said first column of sequentially numbered blocks and said second column of sequentially numbered blocks, while prompting to select between said first option and said second option.

13. The method of playing with the number-matching game board apparatus as claimed in claim 10, wherein said first die-related value has a one-sixth probability of being one, a one-sixth probability of being two, a one-sixth probability of being three, a one-sixth probability of being four, and a two-sixth probability of being five.

14. The method of playing with the number-matching game board apparatus as claimed in claim 10, wherein said second die-related value has a one-sixth probability of being one, a one-sixth probability of being two, a one-sixth probability of being three, a one-sixth probability of being four, and a two-sixth probability of being five.

15. The method of playing with the number-matching game board apparatus as claimed in claim 10, wherein said first column of sequentially numbered blocks is a range between one and ten.

16. The method of playing with the number-matching game board apparatus as claimed in claim 10, wherein said second column of sequentially numbered blocks is a range between one and ten.
